(19) United States
(12) Patent Application Publication
(10) Pub. No.: US 2026/0266868 A1
(43) Pub. Date: Sep. 10, 2026

(54) Machine-Learning Based Methods of Probe Microscopy

(71) Applicant: INFINITESIMA LIMITED, Abingdon, Oxfordshire (GB)

(72) Inventors: Andrew David Laver Humphris, Abingdon (GB); John Patrick Hole, Abingdon (GB)

(21) Appl. No.: 19/469,711

(22) PCT Filed: Mar. 26, 2024
(86) PCT No.: PCT/GB2024/050815

§ 371 Date: Sep. 26, 2025

(30) Foreign Application Priority Data
Mar. 31, 2023 (GB) 2304777.2

(51) Int. Cl. G01Q 30/04; G06N 20/00

(52) U.S. Cl. CPC G01Q 30/04; G06N 20/00

(57) ABSTRACT

A probe microscopy system includes a probe that includes a cantilever mount, a cantilever extending from the cantilever mount to a free end, and a probe tip carried by the free end. The system also includes a drive system configured to drive the probe towards and away from a training sample, and a measurement system configured to acquire probe data in a measurement cycle during which the probe tip interacts with the training sample. The measurement cycle includes a drive phase in which the probe is driven towards the training sample followed by a drive phase in which the probe is driven away from the training sample, and the probe data is acquired by measuring a parameter of the probe. The system further includes a machine-learning model and a training module configured to input the probe data as training data into the model, thereby training the model by machine learning.

### FIELD OF THE INVENTION

The present invention relates to a method of measuring a test sample with a probe, a method of training a machine-learning model by machine learning, and a probe microscopy system.

### BACKGROUND OF THE INVENTION

Scanning probe systems for scanning samples and obtaining information about sample surfaces are known. Typically the scanning probe system comprises a probe that approaches the sample surface and obtains a measurement point upon contacting the sample surface in order to obtain information about the sample.

### SUMMARY OF THE INVENTION

A first aspect of the invention provides a method of measuring a test sample with a probe, as set out in claim 1.

Optionally the output of the trained machine-learning model comprises an image, a profile, a dimension, a figure of merit, or information about the probe.

A second aspect of the invention provides a method of training a machine-learning model by machine learning, as set out in claim 3.

Optionally the method of the second aspect further comprises supplementing the training of the machine-learning model by inputting additional training data into the machine-learning model from a computational model.

A further aspect of the invention provides a method of measuring a test sample with a probe, the method comprising training a machine-learning model by the method of the second aspect, thereby generating a trained machine-learning model, and then measuring a test sample by the method of the first aspect using said trained machine-learning model.

Probe data is acquired in a measurement cycle during which a probe tip interacts with a sample (which may be a training sample or a test sample).

The measurement cycle comprises a first drive phase in which the probe is driven towards the test sample followed by a second drive phase in which the probe is driven away from the test sample. The probe data is acquired by measuring one or more parameters of the probe, for example a height of the probe, and/or an angle of the probe and/or a shape of the probe.

The probe data is input into a machine-learning model, either to train the model or to obtain an output from a trained model. The probe data input into the machine-learning model comprises a dataset of plural measurements of the parameter of the probe, and each measurement in the dataset was acquired during the same measurement cycle. This can be contrasted with more traditional methods in which only a single data point is taken per measurement cycle upon contacting the sample surface (the data point indicating the height of the sample and providing a single pixel of a height profile image).

In the case of a test sample, then the trained machine-learning model generates an output based on the probe data input into the trained machine-learning model. Optionally the output comprises a characteristic of the test sample (for example an image, a profile, a dimension, or a figure of merit). Optionally the output comprises information about the probe. The following optional features apply to all aspects of the invention.

Optionally the dataset input into the machine-learning model was acquired during the first drive phase and/or during the second drive phase.

Optionally the dataset input into the machine-learning model was acquired during the first drive phase.

Optionally the dataset input into the machine-learning model was acquired during the second drive phase.

Optionally the dataset input into the machine-learning model was acquired during the first drive phase and during the second drive phase.

Optionally some of the dataset input into the machine-learning model was acquired when the probe tip was interacting with the sample, and some of the dataset was acquired when the probe tip was not interacting with the sample.

Optionally some of the probe data was acquired when the probe tip was interacting with the sample, and some of the probe data was acquired when the probe tip was not interacting with the sample, and only the probe data which was acquired during the measurement cycle when the probe tip was interacting with the sample is input into the machine-learning model.

Optionally the sample comprises a feature, the feature comprising a trench, hole, well or other indentation; and the probe is driven in and out of the feature during the measurement cycle.

Optionally during the first drive phase the probe is driven down next to a sidewall of the sample, during the second drive phase the probe is driven up next to the sidewall, and during one or both of the drive phases the probe tip interacts with the sidewall.

Optionally the sample comprises a surface which meets the sidewall at a corner, and the method further comprises: acquiring surface probe data in a surface measurement cycle during which the probe tip interacts with the surface, wherein the surface measurement cycle comprising an approach drive phase in which the probe is driven towards the surface followed by a retract drive phase in which the probe is driven away from the surface, and the surface probe data is acquired by measuring a parameter of the probe; and inputting the surface probe data into the machine-learning model, wherein the surface probe data input into the machine-learning model comprises a surface dataset of plural measurements of the parameter of the probe acquired during the same measurement cycle.

Optionally some of the surface dataset was acquired during the surface measurement cycle when the probe tip was interacting with the surface, and some of the surface probe dataset was acquired during the surface measurement cycle when the probe tip was not interacting with the surface.

Optionally the sample comprises an upper surface which meets the sidewall at a convex corner, and a lower surface which meets the sidewall at a concave corner, and the method further comprises: acquiring upper surface probe data in an upper surface measurement cycle during which the probe tip interacts with the upper surface, wherein the upper surface measurement cycle comprising an approach drive phase in which the probe is driven towards the upper surface followed by a retract drive phase in which the probe is driven away from the upper surface, and the upper surface probe data is acquired by measuring a parameter of the probe; inputting the upper surface probe data into the trained machine-learning model, wherein the upper surface probe data input into the machine-learning model comprises an upper surface dataset of plural measurements of the parameter of the probe acquired during the same measurement cycle; acquiring lower surface probe data in a lower surface measurement cycle during which the probe tip interacts with the lower surface, wherein the lower surface measurement cycle comprising an approach drive phase in which the probe is driven towards the lower surface followed by a retract drive phase in which the probe is driven away from the lower surface, and the lower surface probe data is acquired by measuring a parameter of the probe; and inputting the lower surface probe data into the trained machine-learning model, wherein the lower surface probe data input into the machine-learning model comprises a lower surface dataset of plural measurements of the parameter of the probe acquired during the same measurement cycle.

Optionally some of the upper surface dataset was acquired during the upper surface measurement cycle when the probe tip was interacting with the upper surface, some of the upper surface dataset was acquired during the upper surface measurement cycle when the probe tip was not interacting with the upper surface, some of the lower surface probe dataset was acquired during the lower surface measurement cycle when the probe tip was interacting with the lower surface, and some of the lower surface probe dataset was acquired during the lower surface measurement cycle when the probe tip was not interacting with the lower surface.

Optionally the parameter of the probe comprises a height parameter indicative of a height of the probe, or the parameter of the probe comprises an angle parameter indicative of an angle of the probe.

Optionally the probe is driven towards the sample by moving the cantilever mount towards the sample, and the probe is driven away from the sample by moving the cantilever mount away from the sample.

Optionally the probe is driven towards the sample by changing a shape of the cantilever (for example by bending the cantilever), and the probe is driven away from the sample by reversing the change of shape of the cantilever (for example by unbending the cantilever).

Optionally the dataset input into the machine-learning model comprises more than 10 measurements acquired in the same measurement cycle, more than 100 measurements acquired in the same measurement cycle, or more than 1000 measurements acquired in the same measurement cycle.

Optionally the dataset input into the machine-learning model comprises plural measurements of the parameter of the probe acquired during the first drive phase and/or plural measurements of the parameter of the probe acquired during the second drive phase.

Optionally the method further comprises scanning the probe across the sample, and performing plural measurement cycles during which the probe tip interacts with the sample, each measurement cycle comprising acquiring probe data by measuring a parameter of the probe, wherein each measurement cycle comprises a first drive phase in which the probe is driven towards the sample followed by a second drive phase in which the probe is driven away from the sample; and inputting the probe data from the measurement cycles into the machine-learning model, wherein the probe data input into the machine-learning model comprises a global dataset comprising plural datasets of plural measurements of the parameter of the probe, and each measurement in each dataset was acquired during the same measurement cycle.

Optionally the parameter of the probe comprises a height parameter indicative of a height of the probe. The height parameter may be indicative of a height of a base of the cantilever at the cantilever mount, a height of a free end of the cantilever, or a height of any other part of the probe. Optionally the height parameter is read by interferometry.

Optionally the parameter of the probe comprises an angle parameter indicative of an angle of the probe. The angle parameter may be indicative of an angle of a free end of the cantilever, or an angle of any other part of the probe. Optionally the angle parameter is read by an optical lever. Optionally the angle parameter comprises a flexural angle parameter indicative of a flexural angle of the probe, or a torsion angle parameter indicative of a torsion angle of the probe.

Optionally the probe data is acquired by measuring two or more parameters of the probe, and the probe data input into the machine-learning model comprises plural measurements of each parameter of the probe acquired during the same measurement cycle. In one example the two or more parameters may comprise a height parameter indicative of a height of the probe and one or more angle parameters indicative of an angle of the probe. In another example the two or more parameters may comprise a flexural angle parameter indicative of a flexural angle of the probe, and a torsion angle parameter indicative of a torsion angle of the probe.

Optionally the method further comprises detecting an interaction of the probe tip with the sample; and triggering the second drive phase based on the detection.

A further aspect of the invention provides a probe microscopy system comprising: a probe comprising a cantilever mount, a cantilever extending from the cantilever mount to a free end, and a probe tip carried by the free end of the cantilever; a drive system configured to drive the probe towards and away from a sample; a measurement system configured to acquire probe data in a measurement cycle during which the probe tip interacts with the sample, wherein the measurement cycle comprises a first drive phase in which the probe is driven towards the sample followed by a second drive phase in which the probe is driven away from the sample, and the probe data is acquired by measuring a parameter of the probe; a machine-learning model; and a module configured to input the probe data into the machine-learning model, wherein the probe data input into the machine-learning model comprises a dataset of plural measurements of the parameter of the probe acquired during the same measurement cycle.

Optionally the module comprises a training module configured to input the probe data into the machine-learning model, thereby training the machine-learning model by machine learning.

The drive system may comprise a linear actuator which moves the cantilever mount. Alternatively, the drive system may comprise a thermal drive system which changes a shape of the cantilever by illuminating or otherwise heating the cantilever.

### BRIEF DESCRIPTION OF THE DRAWINGS

Embodiments of the invention will now be described with reference to the accompanying drawings, in which:

FIG. 1 is a schematic representation of a scanning probe system in line with an embodiment of the invention;

FIG. 2 is a schematic representation of measurement apparatus incorporated into the system of FIG. 1;

FIG. 3 is a representation of a method in line with an embodiment of the invention;

FIG. 4 schematically illustrates a series of measurement cycles;

FIG. 5 schematically illustrates a trajectory of the probe tip during two sidewall measurement cycles at different distances next to a sidewall;

FIG. 6 is a representation of a sample and datasets collected from the sample using a method in line with an embodiment of the invention;

FIG. 7 shows a method of training a machine-learning model by machine learning;

FIG. 8 shows a method of measuring a test sample with a probe;

FIG. 9 shows two measurement cycles on a flat surface of a training sample;

FIG. 10 shows measurement cycles across an indented feature of a training sample;

FIG. 11 show a training sample and associated dataset; and

FIG. 12 shows measurement cycles across an indented feature of a test sample;

### DETAILED DESCRIPTION OF EMBODIMENT(S)

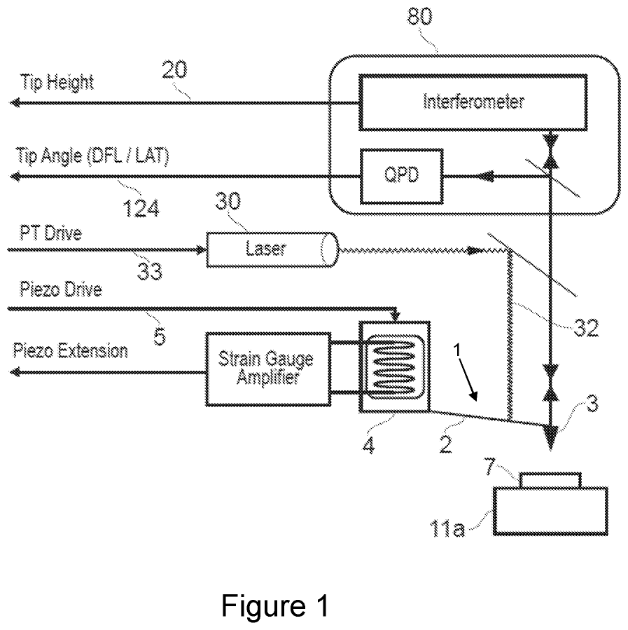

A scanning probe microscopy system according to an embodiment of the invention is shown in FIG. 1. The system comprises a piezoelectric driver 4 and a probe 1 comprising a cantilever 2 and a probe tip 3. The bottom of the piezoelectric driver 4 provides a cantilever mount, with the cantilever 2 extending from the cantilever mount from a proximal end or base to a distal free end. The probe tip 3 is carried by the free end of the cantilever 2.

The probe tip 3 comprises a conical or pyramidal structure that tapers from its base to a point at its distal end that is its closest point of interaction with a sample 7 on a sample stage 11a. The sample comprises a sample surface which defines a sample surface axis which is normal to the sample surface and in FIG. 1 also extends vertically. The cantilever 2 comprises a single beam with a rectangular profile extending from the cantilever mount 13. The cantilever 2 has a length of about 20 micron, a width of about 10 micron, and a thickness of about 200 nm.

In this example the probe tip 3 tapers to a point, but in other embodiments the probe tip 3 may be specially adapted for measuring sidewalls. For instance the probe tip 3 may have a flared shape.

The cantilever 2 is a thermal bimorph structure composed of two (or more) materials, with differing thermal expansions-typically a silicon or silicon nitride base with a gold or aluminium coating. The coating extends the length of the cantilever and covers the reverse side from the tip 3. An illumination system (in the form of a laser 30) under the control of photothermal (PT) drive 33 is arranged to illuminate the cantilever on its upper coated side with an intensity-modulated radiation spot.

The cantilever 2 is formed from a monolithic structure with uniform thickness. For example the monolithic structure may be formed by selectively etching a thin film of SiO₂ or SiN₄ as described in Albrecht T., Akamine, S., Carver, T. E., Quate, C. F. J., Microfabrication of cantilever styli for the atomic force microscope, Vac. Sci. Technol. A 1990, 8, 3386 (hereinafter referred to as “Albrecht et al.”). The tip 3 may be formed integrally with the cantilever, as described in Albrecht et al., it may be formed by an additive process such as electron beam deposition, or it may be formed separately and attached by adhesive or some other attachment method.

The wavelength of the actuation beam 32 output by the laser 30 is selected for good absorption by the coating, so that the cantilever 2 bends along its length and moves the probe tip 3. In this example the coating is on the reverse side from the sample so the cantilever 2 bends down towards the sample when heated, but alternatively the coating may be on the same side as the sample so the cantilever 2 bends away from the sample when heated.

The piezoelectric driver 4 expands and contracts up and down in the Z-direction in accordance with a piezo drive signal 5 at a piezo driver input. As described further below, the piezo drive signal 5 causes the piezoelectric driver 4 to move the probe repeatedly towards and away from the sample 7 in a series of measurement cycles. The piezo drive signal 5 is generated by a piezo controller (not shown). Typically the piezoelectric driver 4 is mechanically guided by flexures (not shown).

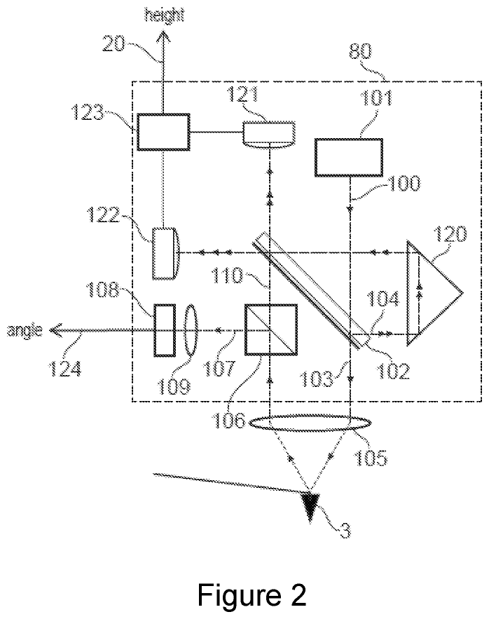

A measurement system 80 is arranged to detect a height and angle of the free end of the cantilever 2 directly opposite to the probe tip 3. The measurement system 80 includes an interferometer which measures height of the free end of the cantilever, and a quadrant photodiode (QPD) which measures angle of the free end of the cantilever. FIG. 1 only shows the measurement system 80 schematically and FIG. 2 gives a more detailed view. Light 100 from a laser 101 is split by a beam splitter 102 into a sensing beam 103 and a reference beam 104. The reference beam 104 is directed onto a suitably positioned retro-reflector 120 and thereafter back to the beam splitter 102. The retro-reflector 120 is aligned such that it provides a fixed optical path length relative to the vertical (Z) position of the sample 7. The beam splitter 102 has an energy absorbing coating and splits both the incident 103 and reference 104 beams to produce first and second interferograms with a relative phase shift of 90 degrees. The two interferograms are detected respectively at first 121 and second 122 photodetectors.

Ideally, the outputs from the photodetectors 121, 122 are complementary sine and cosine signals with a phase difference of 90 degrees. Further, they should have no dc offset, have equal amplitudes and only depend on the position of the cantilever and wavelength of the laser 101. Known methods are used to monitor the outputs of the photodetectors 121, 122 while changing the optical path difference in order to determine and to apply corrections for errors arising as a result of the two photodetector outputs not being perfectly harmonic, with equal amplitude and in phase quadrature. Similarly, dc offset levels are also corrected in accordance with methods known in the art.

These photodetector outputs are suitable for use with a conventional interferometer reversible fringe counting apparatus and fringe subdividing apparatus 123, which may be provided as dedicated hardware, FPGA, DSP or as a programmed computer. Phase quadrature fringe counting apparatus is capable of measuring displacements in the position of the cantilever to an accuracy of A/8. That is, to 66 nm for 532 nm light.

Known fringe subdividing techniques, based on the arc tangent of the signals, permit an improvement in accuracy to the nanometre scale or less. In the embodiment described above, the reference beam 104 is arranged to have a fixed optical path length relative to the Z position of the sample 7. It could accordingly be reflected from the surface of the stage 11a on which the sample 7 is mounted or from a retro-reflector whose position is linked to that of the stage. The reference path length may be greater than or smaller than the length of the path followed by the beam 103 reflected from the probe. Alternatively, the relationship between reflector and sample Z position does not have to be fixed. In such an embodiment the reference beam may be reflected from a fixed point, the fixed point having a known (but varying) relationship with the Z position of the sample. The height of the tip is therefore deduced from the interferometrically measured path difference and the Z position of the sample with respect to the fixed point.

The interferometer detector is one example of a homodyne system. The particular system described offers a number of advantages to this application. The use of two phase quadrature interferograms enables the measurement of cantilever displacement over multiple fringes, and hence over a large displacement range. Examples of an interferometer based on these principles are described in U.S. Pat. No. 6,678,056 and WO2010/067129. Alternative interferometer systems capable of measuring a change in optical path length may also be employed. A suitable homodyne polarisation interferometer is described in EP 1 892 727 and a suitable heterodyne interferometer is described in U.S. Pat. No. 5,144,150.

Returning to FIG. 1, the output of the interferometer is a height signal on a height detection line 20 which is input to a surface height calculator (not shown) and a surface detection unit (not shown). The surface detection unit is arranged to generate a surface signal on a surface detector output line for each cycle when it detects an interaction of the probe tip 3 with the sample 7.

The reflected beam is also split by a beam splitter 106 into first and second components 107, 110. The first component 107 is directed to a segmented quadrant photodiode 108 via a lens 109, and the second component 110 is split by the beam splitter 102 and directed to the photodiodes 121, 122 for generation of the height signal on the output line 20. The photodiode 108 generates angle data 124 which is indicative of the position of the first component 107 of the reflected beam on the photodiode 108 and varies in accordance with the angle of inclination of the cantilever relative to the sensing beam 103.

The angle data 124 comprises a deflection/bending signal which indicates a flexural angle of the cantilever—i.e an angle which changes as the cantilever bends along its length. Thus the deflection/bending signal is indicative of the flexural angle of the cantilever. The deflection/bending signal may be determined in accordance with a difference between the signals from the top and bottom halves of the quadrant photodiode 108.

The angle data 124 also comprises a lateral/twisting signal which indicates a torsion angle of the cantilever—i.e an angle which changes as the cantilever twists. Thus the lateral/twisting signal is indicative of the torsional angle of the cantilever. The lateral/twisting signal may be determined in accordance with a difference between the signals from the left and right halves of the quadrant photodiode 108.

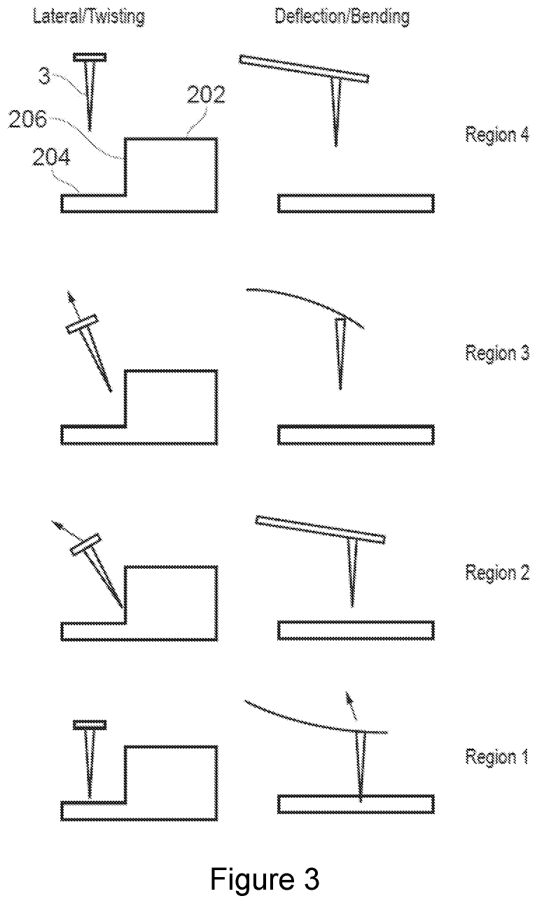

FIG. 3 shows the steps of a measurement of a sidewall of the sample 7. The sample 7 comprises an upper surface 202, a lower surface 204 and a sidewall 206 between the upper surface 202 and the lower surface 204. The upper surface 202 meets the apex of the sidewall 206 at a convex corner and the lower surface 204 meets the base of the sidewall 206 at a concave corner. The sidewall 206 may form part of a structure in the sample such as a well or a protrusion.

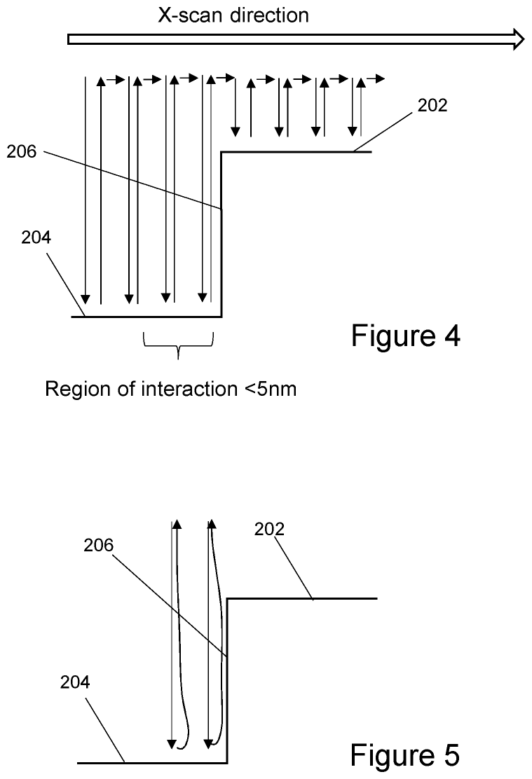

During scanning of the upper and lower surfaces, the probe is made to approach and retract from the sample 7 in a series of measurement cycles shown in FIG. 4, each approach and retract drive phase makes up one cycle which involves taking a single measurement point when the probe contacts the sample surface.

The probe is scanned laterally across the sample by an XY driver which drives the probe in a raster scanning pattern. FIG. 4 indicates the X-scan direction of the raster scanning pattern. In this example the motion of the cantilever mount is indicated by the arrows in FIG. 4. In each measurement cycle the cantilever mount moves vertically down then vertically up. The horizontal motion is driven by the XY driver. The XY driver may continuously move the probe in the X-scan direction, or it may move the probe in a “stop-start” motion with no motion in the X-scan direction as the probe approaches and retracts.

A dither signal may be applied to the probe during the first (approach) drive phase as a means of determining contact with the lower surface 204. The dither signal is applied using a signal from the photothermal drive 33 to illuminate the back of the cantilever 2 with an actuation beam 32. Using this actuation beam 32 it is possible to cause the probe to oscillate with a dither oscillation. For each measurement cycle, the dither oscillation, as measured by the interferometer or the quadrant photodiode, is monitored to detect contact of the probe with the sample. For example the phase or amplitude of the dither oscillation may change and this change may be detected to detect the contact.

In an alternative embodiment, the deflection/bending signal may be monitored to detect contact of the probe with the sample. For example the deflection/bending signal may change abruptly as the probe contacts the sample, and this change may be detected to detect the contact. In this case, no dither signal is required so the photothermal actuation system 33, 30 may be omitted and the cantilever 2 does not need to have a thermal bimorph structure.

FIG. 4 illustrates a series of four upper surface measurements of the upper surface 202. Each upper surface measurement is taken during an upper surface measurement cycle, the upper surface measurement cycle comprising an approach drive phase in which the cantilever mount is driven down so that the probe is driven down to the upper surface 202 followed by a retract drive phase in which the cantilever mount is driven up so that the probe is driven up and away from the upper surface 202. A surface measurement is taken for each upper surface measurement cycle, by taking a height reading from the interferometer detector when contact with the upper surface 202 is detected by monitoring the dither oscillation. The approach drive phase may be terminated in response to the detection of the contact of the probe with the sample. Optionally the dither signal is not applied to the probe during the retract drive phase.

FIG. 4 also illustrates a series of two lower surface measurements of the lower surface 204. Each lower surface measurement is taken during a lower surface measurement cycle, the lower surface measurement cycle comprising an approach drive phase in which the cantilever mount is driven down so that the probe is driven down to the lower surface 204 followed by a retract drive phase in which the cantilever mount is driven up so that the probe is driven up and away from the lower surface 204. A surface measurement is taken for each lower surface measurement cycle, by taking a height reading from the interferometer detector when contact with the lower surface 204 is detected by monitoring the dither oscillation. The approach drive phase may be terminated in response to the detection of the contact of the probe with the sample. Optionally the dither signal is not applied to the probe during the retract drive phase.

When in proximity to the sidewall 206, within a region of interaction of the order of 5 nm indicated in FIG. 4, the probe undergoes a pair of sidewall measurement cycles. Each sidewall measurement cycle comprises a pair of sidewall measurement drive phases. The pair of sidewall measurement drive phases comprises a first drive phase in which the cantilever mount is driven down so that the probe is driven down (i.e. towards the base of the sidewall) followed by a second drive phase in which the cantilever mount is driven up so that the probe is driven up (i.e. away from the base of the sidewall).

During each drive phase of a sidewall measurement cycle, the probe is next to the sidewall 206. In this context, “next to” means adjacent to, and possibly but not necessarily interacting with the sidewall 206. The probe is sufficiently close to the sidewall, that during at least one of the drive phases it lies within a region of interaction. The region of interaction will depend on the nature of the sample and the probe, for instance whether the sample and/or the probe is charged. By way of non-limiting example, during each sidewall measurement cycle the probe tip may be within 100 nm of the sidewall, within 50 nm of the sidewall, within 10 nm of the sidewall, or within 5 nm of the sidewall.

During the sidewall measurement cycle the sidewall 206 applies a force to the probe tip 3 which causes the cantilever to twist, such that during one or both of the sidewall measurement drive phases the probe tip 3 interacts with the sidewall 206.

In the example of FIG. 5 the force is an attractive force resulting from the Van der Waals interaction, and the probe tip 3 interacts with the sidewall 206 during the second drive phase in which the probe is driven up next to the sidewall 206.

A series of sidewall measurements are taken by measuring an angle of the cantilever as the probe tip interacts with the sidewall during the second sidewall measurement drive phase.

FIG. 5 schematically illustrates motion of the probe tip during the pair of sidewall measurement cycles. In the first drive phase the probe tip moves down vertically next to the sidewall, then “snaps” into contact with the sidewall. In the second drive phase the probe tip is dragged up the sidewall. The Van der Waals interaction reduces as the probe is retracted, so the cantilever untwists and the probe tip moves away from the sidewall as it moves up.

If a dither signal is applied to the probe during the first drive phase of each sidewall measurement cycle to cause a dither oscillation of the probe, then the dither oscillation may be monitored to detect contact of the probe with the sample. The first drive phase may be terminated in response to the detection of the contact of the probe with the sample. Optionally the dither signal is applied to the probe during the first drive phase and not applied to the probe during the second drive phase. This lack of dither signal in the second drive phase makes it easier to accurately measure the angle of the cantilever as it interacts with the sidewall.

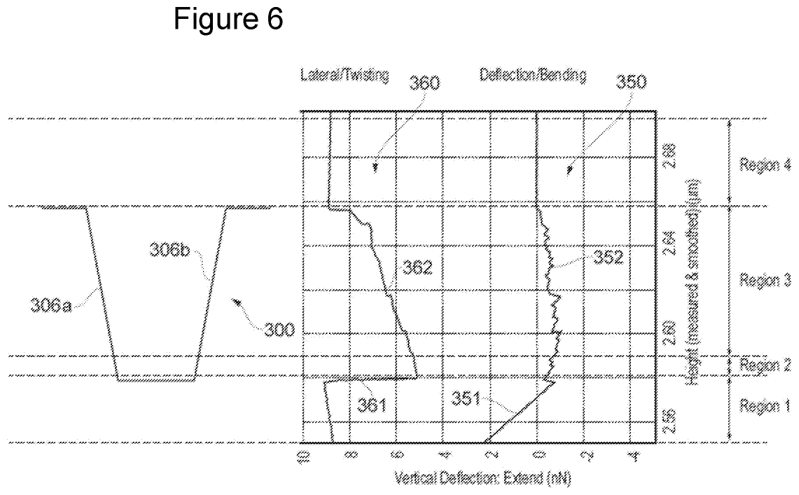

In the example of FIG. 5, at the end of each first drive phase the probe contacts the lower surface 204 and the detection of this contact triggers the reversal of the driver 4 and the retraction of the probe in the second drive phase. In other embodiments, for instance with an angled sidewall 306b as shown in FIG. 6, the probe may contact the sidewall 306b without contacting the lower surface.

Starting from the base of the sidewall 206, four regions making up the second drive phase are shown in FIG. 3. For each region, the lateral/twisting motion of the probe is shown on the left-hand side of FIG. 3, with the cantilever extending into or out of the page in these figures. The deflection/bending motion of the probe is also shown for each region on the right-hand side of FIG. 3, with the sidewall behind or in front of the probe in or out of the page.

Starting at region 1, the probe is in contact with the lower surface 204 and is pushing into this surface slightly. There is therefore no or negligible twisting of the probe, but there is some positive deflection, due to the probe tip 3 being pushed into the lower surface 204.

Region 2 shows the lateral/twisting and deflection/bending motion when the probe is retracted slightly. No longer pushed into the lower surface 204, the probe unbends and is attracted towards the sidewall 206 by the Van der Waals force. There is therefore some twisting experienced. However, the probe has unbent so there is no deflection/bending.

Region 3 shows the lateral/twisting and deflection/bending motion when the probe is retracted further up the sidewall 206. The probe continues to be attracted to the sidewall 206 by the Van der Waals force. As the piezoelectric driver moves the probe up, the probe is dragged up the sidewall 206. It moves in a sliding or stick/slip motion, temporarily sticking on the sidewall due to attractive forces from features of the sidewall, then unsticking as force from the driver 4 moving the probe upwards overcomes the attractive force. The probe remains in a twisted state, and slides up the sidewall, sometimes in contact with and sometimes not in contact with the sidewall as it becomes stuck and unstuck. The cantilever 2 is deflected negatively when the probe tip 3 sticks to the sidewall 206.

Region 4 shows the probe when it has been fully retracted, to the point where there is no or negligible attractive force between the probe and the sidewall 206. There is no twisting and no deflection of the probe.

By obtaining a series of measurements of the lateral/twisting signal and the deflection/bending signal as the probe is retracted, it is possible to determine a characteristic of the sidewall 206. This may be a geometric characteristic, such as a profile or shape of the sidewall 206, or a material characteristic for example.

Each series of sidewall measurements comprises a dataset or “sidewall signature”, which provides information about a characteristic of the sidewall.

In FIGS. 4 and 5, the series of sidewall measurements for each measurement cycle are taken by measuring an angle of the cantilever as the probe interacts with the sidewall during the second drive phase—i.e. by taking a series of samples of the lateral/twisting signal and the deflection/bending signal as the probe tip slides up the sidewall. A probe height measurement is also taken at the same time as each sidewall measurement. As explained below, the probe height measurements may be taken from the piezo drive signal 5, or from the interferometer.

A series of sidewall measurements for each measurement cycle may also be taken by measuring an angle of the cantilever as the probe interacts with the sidewall during the first drive phase—i.e. as the probe tip slides down the sidewall. In the first drive phase the probe tip slides down the sidewall (i.e. towards the base of the sidewall) and the series of sidewall measurements are taken. In the second drive phase the probe tip moves up next to the sidewall, i.e. away from the base of the sidewall.

FIG. 6 shows a typical well 300 in a sample surface, the well having a pair of sidewalls 306a, 306b. The sidewalls 306a, 306b in this example are substantially straight.

Trace 350 indicates the deflection/bending signal, which is plotted along with the height of the cantilever. Trace 360 indicates the lateral/twisting signal, which is plotted along with the height of the cantilever.

Note that the scale in FIG. 6 labelled as “Vertical Deflection Extend (nN)” is associated with the deflection/bending signal, and not with the lateral/twisting signal. This scale is based on the deflection/bending signal multiplied by the flexural spring constant of the cantilever-giving a force in nN.

The other scale in FIG. 6 (labelled as “Height (measured and smoothed) μm)”) is based on the piezo drive signal 5 (which controls the piezoelectric driver 4 which drives the base of the cantilever 2). Thus this scale effectively indicates the height of the proximal end or base of the cantilever, rather than the height of the distal end which carries the probe tip.

The cantilever changes shape as the probe tip slides up the sidewall, and the series of sidewall measurements vary in accordance with the changing shape of the cantilever, as indicated by the traces 350 and 360.

The series of sidewall measurements, represented by traces 350 and 360, will typically comprise 100s or 1000s of sidewall measurements, each sidewall measurement comprising a single sample from the quadrant photodiode.

When the probe is in Region 1, the probe height is at a minimum (about 2.55 μm) and the cantilever is bent up, as indicated in FIG. 3. So the deflection/bending signal, indicated by trace 350, is also at a maximum (about 2nN). As the piezoelectric driver 4 retracts, the cantilever unbends (as indicated by section 351 of the trace 350) until the probe tip lifts off from the lower surface.

Note that in this example a series of probe height measurements are taken which are indicative of a height of the base of the cantilever at the cantilever mount. In other words, the height component of each trace 350, 360 is based on the piezo drive signal 5 and thus effectively indicates the height of the proximal end or base of the cantilever at the cantilever mount, rather than the height of the distal end which carries the probe tip. This can be seen from the fact that in Region 1 the height component of the trace 350 is changing, even though the probe tip remans in contact with the lower surface.

Optionally a series of probe height measurements may also be taken which are indicative of a height of the free end of the cantilever. In a first example such probe height measurements may be made by subtracting the deflection/bending signal from the piezo drive signal 5. In a second example such probe height measurements may be based instead on the height signal 20 from the interferometer.

As the probe tip lifts off, at the end of Region 1, the Van der Waals force or other attractive forces causes the probe tip to snap into contact with the sidewall, and the lateral/twisting signal goes sharply negative (as indicated by section 361 of the trace 360).

In Region 3 the cantilever gradually untwists (as indicated by section 362 of the trace 360) and the cantilever is slightly bent down (as indicated by section 352 of the trace 350).

Both of these signals contain information about the sidewall, so the series of sidewall measurements in Region 3 can be analysed to determine a characteristic of the sidewall.

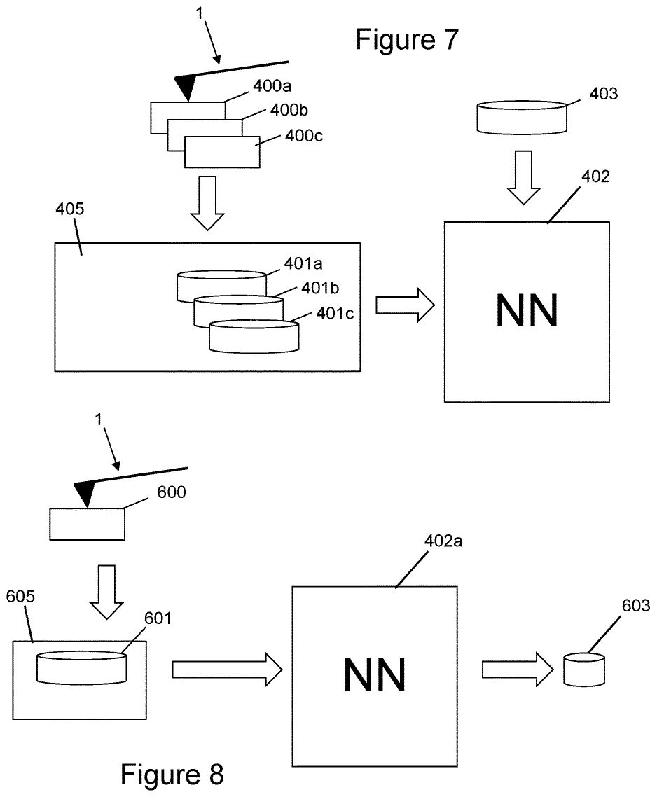

Machine-learning model based methods are shown in FIGS. 7 and 8.

FIG. 7 shows a method of training a machine-learning model 402, which in this case is a neural network although any other type of model capable of machine learning may be used.

In the method of FIG. 7, a plurality of training samples 400a-c are provided, each having a different known characteristic.

For each training sample 400a-c, probe data 401a-c is acquired by measuring an interaction of the probe 1 (or another similar probe) with the training sample. A training module 405 is configured to store the probe data 401a-c and input some or all of the probe data 401a-c as training data into the machine-learning model 402, thereby training the machine-learning model 402 by machine learning.

The probe data 401a-c is acquired from the training samples 400a-c in a series of measurement cycles. The traces 350, 351 in FIG. 6 give one example of probe data from a single measurement cycle which may be acquired and then input into the machine learning model 402.

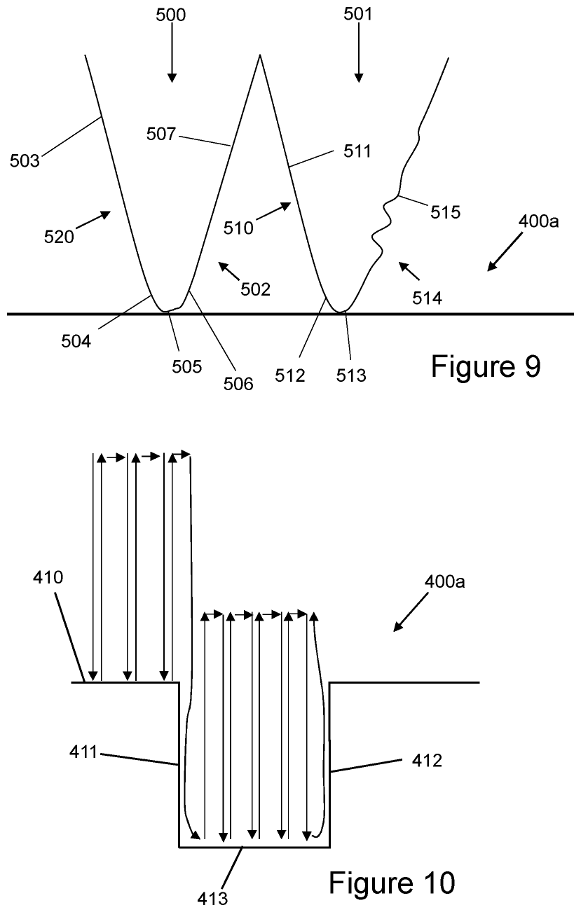

FIG. 9 gives another example of a trajectory of the probe tip during two measurement cycles 500, 501 in a relatively flat part of a training sample 400a.

The first measurement cycle 500 comprise a first drive phase 520 in which the probe mount 4 is driven towards the training sample 400a followed by a second drive phase 502 in which the probe mount 4 is driven away from the training sample. In a first part of the first drive phase 520 the probe tip moves along a straight trajectory 503 without interacting with the training sample 400a. In a second part of the first drive phase 520 the probe tip interacts with the training sample, causing the probe tip to follow a more complex curved trajectory 504 depending on the interaction.

At point 505 the surface detection unit detects the interaction of the probe tip with the training sample 400a and triggers the second drive phase based on the detection. This initiates the second drive phase 502 in which the probe mount 4 is driven away from the training sample 400a. In a first part of the second drive phase the probe tip continues to interact with the training sample, causing the probe tip to follow a complex curved trajectory 506 depending on the interaction. In a second part of the second drive phase the probe tip moves along a straight trajectory 507 without interacting with the training sample 400a.

In the first measurement cycle 500 of FIG. 9 there is little or no adhesion between the probe tip and the training sample 400a. In the second measurement cycle 501 of FIG. 9, tip adhesion causes the probe tip to follow a more complex path during the second drive phase.

In a first part of the first drive phase the probe tip moves along a straight trajectory 511 without interacting with the training sample. In a second part of the first drive phase the probe tip interacts with the training sample 400a, causing the probe tip to follow a more complex curved trajectory 512 depending on the interaction.

At point 513 the surface detection unit detects the interaction of the probe tip with the training sample and triggers the second drive phase based on the detection. This initiates the second drive phase 501 in which the probe mount 4 is driven away from the training sample 400a. Due to adhesion of the probe tip, the probe tip remains in contact with the sample until the retraction of the cantilever mount 4 overcomes the adhesion force and the probe tip springs rapidly away from the training sample 400a. This causes a complex oscillatory twisting/bending motion of the cantilever 2 so the probe tip follows a complex trajectory 515 indicated schematically in FIG. 9, despite the fact that there is little or no interaction between the probe tip and the training sample at this point in time.

FIG. 10 gives an example of a trajectory of the probe tip during measurement cycles as the probe tip is scanned across a feature of the training sample 400a which may be a trench, hole, well or other indentation.

The training sample 400a comprises upper surfaces 410 which each meet a respective sidewall 411, 412 at a respective convex corner. A lower surface 413 of the feature meets each sidewall 411, 412 at a respective concave corner.

Upper surface probe data is acquired in a series of upper surface measurement cycles (three being shown in FIG. 10) during which the probe tip interacts with the upper surface 410. Each upper surface measurement cycle comprising an approach drive phase in which the probe is driven towards the upper surface 410 followed by a retract drive phase in which the probe is driven away from the upper surface 410. The upper surface probe data is acquired by measuring one or more parameters of the probe 1: for instance a height of the probe which is measured by interferometry and/or an angle of the cantilever which is measured by the segmented quadrant photodiode 108.

The next measurement cycle comprises a first sidewall measurement cycle with a first drive phase during which the probe is driven down next to a first sidewall 411 of the feature, and a second drive phase during which the probe is driven up next to the first sidewall 411. During one or both of these drive phases the probe tip interacts with the first sidewall 411, for instance with a sliding interaction or a stick/slip interaction. Sidewall probe data is acquired by measuring one or more parameters of the probe during the first sidewall measurement cycle.

Lower surface probe data is then acquired in a series of lower surface measurement cycles (three being shown in FIG. 10) during which the probe tip interacts with the lower surface 413. Each lower surface measurement cycle comprising an approach drive phase in which the probe is driven towards the lower surface 413 followed by a retract drive phase in which the probe is driven away from the lower surface 413. The probe tip is driven in and out of the feature during each lower surface measurement cycle.

The next measurement cycle is a second sidewall measurement cycle comprising a first drive phase during which the probe is driven down next to a second sidewall 412 of the feature, and a second drive phase during which the probe is driven up next to the second sidewall 412. During one or both of the drive phases the probe tip interacts with the second sidewall 412, for instance with a sliding interaction or a stick/slip interaction. Sidewall probe data is acquired by measuring one or more parameters of the probe during the second sidewall measurement cycle.

The lower surface probe data, the upper surface data and the sidewall probe data are acquired by measuring one or more parameters of the probe 1: for instance a height of the probe which is measured by interferometry and/or an angle of the cantilever which is measured by the segmented quadrant photodiode 108.

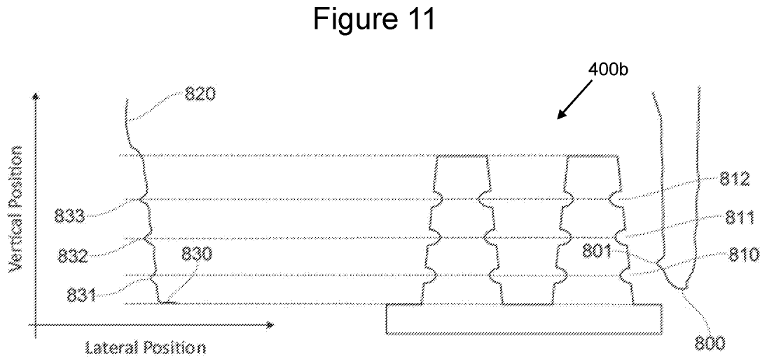

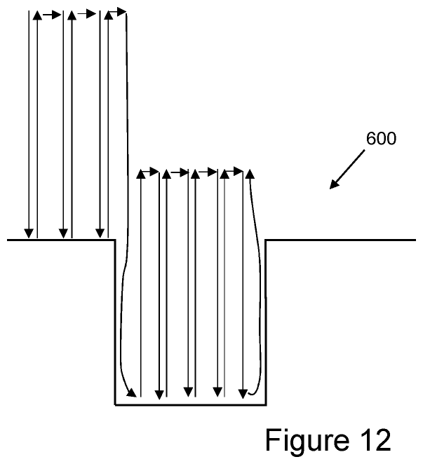

FIG. 11 shows a part of a training sample 400b being scanned by a probe. FIG. 11 shows the distal end of the probe tip including its apex 800. In this example the probe tip has an asperity (a small protrusion) 801 extending laterally from the probe tip, near the apex 800 of the probe tip.

The training sample 400b has sidewalls with notches 810-812. Each sidewall is measured by taking a series of measurements of the sidewall with the probe over one or more measurement cycles as described above.

In this example, as the probe is driven up next to the sidewall by the piezoelectric driver 4, the probe tip interacts with the sidewall, and a series of measurements are taken.

At each point in time, a lateral position is obtained along with an associated vertical position. Together, these positions can be interpreted as representing the position of the apex 800 of the probe tip as the probe tip slides up the sidewall.

A time series of such positions is illustrated by the trace 820 in the left-hand side of FIG. 11, which can be considered as a dataset or sidewall signature representing a trajectory of the apex 800 of the probe tip.

The vertical position for each point of the trace 820 may be a height measurement obtained by measuring a height of the cantilever as the probe tip interacts with the sidewall. For instance the vertical position may be calculated from the extension of the piezoelectric driver 4 (which can be measured directly or inferred from the piezo drive signal 5); and the deflection/bending signal which indicates a flexural angle of the cantilever (and which can be measured by the vertical position of the first component 107 on the segmented quadrant photodiode 108, or by any other means). Alternatively, the vertical position for each point of the trace 820 may be measured directly by the height signal on the height detection line 20, which provides a direct interferometric measurement of the height of the free end of the cantilever.

The lateral position for each point of the trace 820 may be a sidewall probe measurement based on the lateral/twisting signal which indicates a torsion angle of the cantilever—i.e an angle which changes as the cantilever twists. Thus the lateral/twisting signal is indicative of the torsional shape of the cantilever. The lateral/twisting signal may be determined in accordance with a difference between the signals from the left and right halves of the quadrant photodiode 108.

At the start of the drive phase in which the probe is driven up next to the sidewall, the probe tip snaps laterally, bringing the asperity 801 into contact with the sidewall as indicated at 830. Then as the piezoelectric driver 4 contracts, the asperity 801 slides up the sidewall and into the first notch 810, resulting in a first feature 831 in the trace 820. This process continues as the probe tip is driven up next to the sidewall, providing further features 832, 833 associated with the notches 811, 812.

Returning to FIG. 7, the probe data 401a acquired during the scanning of the training sample 400a is input into the machine-learning model 402, as well as probe data 401b, 401c acquired during the scanning of the other training samples 400b and 400c respectively. This trains the machine-learning model 402 by machine learning and transforms it into a trained machine-learning model 402a shown in FIG. 8.

The machine learning process of FIG. 7 may be supervised or unsupervised. In the case of supervised machine learning, the different known characteristics of the training samples 400a-c may be used, along with the probe data 401a-c, to train the machine-learning model 402 by supervised machine learning. By way of example, the training samples 400a-c may have trenches with known and differing widths, the known widths providing the known characteristic which is used for the supervised machine learning process. In another example, the training samples 400a-c may have the same profile, but different known electrostatic charge states, the known electrostatic charge states providing the known characteristic which is used for the supervised machine learning process.

The training of the machine-learning model 402 may be supplemented by inputting additional training data 403 into the machine-learning model 402 from a computational model.

Each measurement cycle generates a dataset of plural measurements of one or more parameters of the probe, where each measurement in the dataset was acquired during the same measurement cycle. The number of measurements per measurement cycle will be determined by the capacity to acquire and store large quantities of data, and the ability of the machine-learning model 402 to process such large quantities of data. By way of example each measurement cycle may generate a dataset of 256, 512, 1024, 2048 or 4096 measurements.

The probe is scanned across the training sample 400a and performs plural measurement cycles during which the probe tip interacts with the sample as shown in FIGS. 9-11 by way of example. The number of measurement cycles will be determined by the capacity to acquire and store large quantities of data, and the ability of the machine-learning model 402 to process such large quantities of data. By way of example, a 256*256 array of measurement cycles may be performed, or a 512*512 array of measurement cycles may be performed.

Taking the example of a 512*512 array of measurement cycles, each generating a dataset of 4096 measurements, each measurement being stored as 16 bits of data, a global dataset (i.e. a collection of datasets from all measurement cycles) of about 2 GB may be generated.

Preferably the probe data from all of the measurement cycles of the training sample 400a (i.e. the global dataset) is input into the machine-learning model 402.

The probe data 401a may be input into the machine-learning model 402 “on the fly” during the scanning of the training sample 400a, or in a post-processing batch procedure after the scan of the training sample 400a is complete.

As can be seen in FIGS. 9 and 10, for most (or all) measurement cycles, some of the dataset for that measurement cycle was acquired when the probe tip was interacting with the sample, and some of the dataset was acquired when the probe tip was not interacting with the sample. Traditionally, probe data acquired when a probe tip is not interacting with the sample is either discarded or ignored, but it has been realised that inputting such probe data into the machine-learning model 402 as shown in FIG. 7 can assist the machine-learning process. For instance, the length of the straight trajectories 503, 507, 511 of FIG. 9 may provide useful information to the machine-learning model. Also, the complex trajectory 515 may contain useful information about the adhesive interaction between the probe tip and the training sample, despite the fact that there is little or no interaction between the probe tip and the training sample during this complex trajectory 515.

Alternatively, if the machine-learning model 402 is not able to process large quantities of data, then the probe data acquired when the probe tip is not interacting with the sample may be discarded or ignored, so only the probe data which was acquired during the measurement cycle when the probe tip was interacting with the test sample is input into the machine-learning model 402.

Probe data acquired when the probe tip was interacting with the sample can also provide useful information about the profile of the sample and/or other characteristics of the sample (for example material properties or electrostatic charge state). For example, the probe datasets acquired as the probe tip follows the curved trajectories 504, 506, 512 in FIG. 9 might provide information about the material properties of the sample, and the probe datasets taken in FIG. 10 as the probe tip slides up or down the wall may provide information about the profile or angle of the wall.

Similarly, datasets in the form of sidewall signatures (as represented by traces 350, 360 in FIG. 6 or the trace 820 in FIG. 11) may be input into the machine-learning model 402. In this case the machine-learning process may train the machine-learning model 402 to recognise a characteristic of a sidewall: for instance the angles of the sidewalls 306a,b; the vertical spacing between the notches 810-812; the depth of the notches 810-12; or the width of the notches 810-812.

Note that the height measurements from FIG. 6 and FIG. 11 may be input into the machine-learning model 402 along with the sidewall measurements.

The training of the model 402 shown in FIG. 7 modifies the weights between nodes of the neural network. This transforms the un-trained model 402 into a trained model 402a shown in FIG. 8.

Once the trained machine-learning model 401a has been generated by the machine learning process of FIG. 7, it can be used to analyse an unknown test sample 600 by the method of FIG. 8.

The method of measuring the test sample 600 in FIG. 8 is identical to the method of measuring the training samples 400a-c as exemplified in FIGS. 9-11. That is, the probe 1 (or another similar probe) is scanned across the test sample 600, and plural measurement cycles are performed during which the probe tip interacts with the test sample 600. In each measurement cycle, probe data is acquired by measuring one or more parameters of the probe, and each measurement cycle comprises a first drive phase in which the probe is driven towards the test sample 600 followed by a second drive phase in which the probe is driven away from the test sample 600.

FIG. 12 gives an example of a trajectory of the probe tip during measurement cycles across an indented feature of the test sample 600 which is similar to the indented feature of the training sample 400a shown in FIG. 10. The scanning of the feature of FIG. 12 is identical to the scanning process described with reference to FIG. 10, so will not be repeated.

The lower surface probe data, the upper surface data, and the sidewall probe data are acquired from the test sample 600 as shown in FIG. 12, and input into the trained machine-learning model 402a as part of a dataset 601. The inputting of the probe data 601 into the trained machine-learning model 402a is managed and performed by an input module 605.

An output 601 from the trained machine-learning model 402a is then received, based on the probe data 601 input into the trained machine-learning model 402a.

By way of example, the output 601 may comprise information about the test sample 600, such as an image, a profile, a dimension (such as the height or width of the indented feature of FIG. 12) or a figure of merit (such as a number indicating the quality of the sidewalls of the indented feature of FIG. 12).

Alternatively the output 603 may comprise information about the probe 1 which was used to scan the test sample 600. If the test sample 600 has known characteristics, then the probe data 601 may give an indication of the state of wear of the probe 1. Thus the output 603 of the trained machine-learning model 402a may comprise information indicating a state of wear of the probe 1. This enables the probe 1 to be replaced when the state of wear reaches a threshold.

At a minimum, the probe data 601 input into the trained machine-learning model 402a may consist of only a single dataset of plural measurements from only a single measurement cycle, such as the dataset (or signature) shown in the graph of FIG. 11, the dataset of deflection/bending measurements represented by the trace 350 of FIG. 6, or the dataset of lateral/twisting measurements represented by the trace 360 of FIG. 6. More typically the probe data 601 input into the trained machine-learning model 402a comprises probe data from plural measurement cycles: for instance probe data from the nine measurement cycles of FIG. 10, or a 2 GB global dataset as described above from a much larger number of measurement cycles.

The probe data 601 may be input into the trained machine-learning model 402a “on the fly” during the scanning of the test sample 600, or in a post-processing batch procedure after the scan of the test sample 600 is complete.

As previously discussed with reference to the training method of FIG. 7, for most (or all) measurement cycles, some of the dataset for that measurement cycle was acquired when the probe tip was interacting with the sample, and some of the dataset was acquired when the probe tip was not interacting with the sample. Inputting both types of probe data into the trained machine-learning model 402a as shown in FIG. 8 can assist the process of characterising the test sample 600 and/or characterising the probe 1.

Alternatively, if the trained machine-learning model 402a is not able to process large quantities of data, then the probe data acquired when the probe tip is not interacting with the sample may be discarded or ignored by the input module 605, so only the probe data which was acquired during the measurement cycle when the probe tip was interacting with the test sample 400a is input into the trained machine-learning model 402a.

In the examples given above, for each measurement cycle the probe 1 is driven towards the sample by moving the cantilever mount towards the sample (by expansion of the piezoelectric driver 4) and the probe 1 is driven away from the sample by moving the cantilever mount away from the sample (by contraction of the piezoelectric driver 4). This actuation method may be preferred because it enables the probe to be moved without changing its angle.

In other embodiments of the invention, the probe may be driven towards the sample by changing a shape of the cantilever 2 (for example by bending the cantilever 2) and the probe may be driven away from the sample by reversing the change of shape of the cantilever 2 (for example by unbending the cantilever). This bending and unbending of the cantilever 2 may be driven by the laser 30, by an electrical heating element in the cantilever 2, or by any other means. Such an actuation method may be preferred (compared with moving the cantilever mount 4) because it may enable the sample to be scanned more quickly. Although the change of shape of the cantilever may cause a change in the deflection/bending signal and/or the lateral/twisting signal, it is expected that the machine-learning model 402/402a will still be able distinguish between different samples.

In the example of FIG. 1, the probe microscope has an interferometer which measures the height of the distal or free end of the cantilever 2 which carries the probe tip 3, and a quadrant photodiode which measures the angle of the distal or free end of the cantilever 2. The probe data from the interferometer and/or the probe data from the quadrant photodiode may be input into the machine-learning model 402/402a. In another embodiment, the interferometer may illuminate the cantilever at more than one position, thereby measuring its height at different points (for instance two points at the free end of the cantilever, or one point towards the base of the cantilever and another at the free end). Again, the height measurements at all points may be input into the machine-learning model and may give better information about the dynamic behaviour of the cantilever. Likewise, a second optical lever with a second quadrant photodiode may be used to detect the angle of another part of the cantilever.

Although the invention has been described above with reference to one or more preferred embodiments, it will be appreciated that various changes or modifications may be made without departing from the scope of the invention as defined in the appended claims.

1. A method of measuring a test sample with a probe, the probe comprising a cantilever mount, a cantilever extending from the cantilever mount to a free end, and a probe tip carried by the free end of the cantilever, the method comprising:
acquiring probe data in a measurement cycle during which the probe tip interacts with the test sample, wherein the measurement cycle comprises a first drive phase in which the probe is driven towards the test sample followed by a second drive phase in which the probe is driven away from the test sample, and the probe data is acquired by measuring a parameter of the probe;
inputting the probe data into a trained machine-learning model, wherein the probe data input into the trained machine-learning model comprises a dataset of plural measurements of the parameter of the probe acquired during the same measurement cycle; and
receiving an output from the trained machine-learning model based on the probe data input into the trained machine-learning model.

2. A method according to claim 1, wherein the output of the trained machine-learning model comprises an image, a profile, a dimension, a figure of merit, or information about the probe.

3. A method of training a machine-learning model by machine learning, the method comprising:
measuring a training sample with a probe, the probe comprising a cantilever mount, a cantilever extending from the cantilever mount to a free end, and a probe tip carried by the free end of the cantilever;
acquiring probe data in a measurement cycle during which the probe tip interacts with the training sample, wherein the measurement cycle comprises a first drive phase in which the probe is driven towards the training sample followed by a second drive phase in which the probe is driven away from the training sample, and the probe data is acquired by measuring a parameter of the probe; and
inputting the probe data into a machine-learning model, thereby training the machine-learning model by machine learning, wherein the probe data input into the machine-learning model comprises a dataset of plural measurements of the parameter of the probe acquired during the same measurement cycle.

4. (canceled)

5. A method of measuring a test sample with a probe, the method comprising training a machine-learning model by the method of claim 3, thereby generating a trained machine-learning model, and then measuring a test sample, using said trained machine-learning model, by:
acquiring probe data in a measurement cycle during which the probe tip interacts with the test sample, wherein the measurement cycle comprises a first drive phase in which the probe is driven towards the test sample followed by a second drive phase in which the probe is driven away from the test sample, and the probe data is acquired by measuring a parameter of the probe;
inputting the probe data into a trained machine-learning model, wherein the probe data input into the trained machine-learning model comprises a dataset of plural measurements of the parameter of the probe acquired during the same measurement cycle; and
receiving an output from the trained machine-learning model based on the probe data input into the trained machine-learning model.

6. (canceled)

7. A method according to claim 1, wherein the dataset input into the machine-learning model was acquired during the first drive phase.

8. A method according to claim 1, wherein the dataset input into the machine-learning model was acquired during the second drive phase.

9. A method according to claim 1, wherein the dataset input into the machine-learning model was acquired during the first drive phase and during the second drive phase.

10. A method according to claim 1, wherein some of the dataset input into the machine-learning model was acquired when the probe tip was interacting with the sample, and some of the dataset was acquired when the probe tip was not interacting with the sample.

11. A method according to claim 1, wherein some of the probe data was acquired when the probe tip was interacting with the sample, and some of the probe data was acquired when the probe tip was not interacting with the sample, and only the probe data which was acquired during the measurement cycle when the probe tip was interacting with the sample is input into the machine-learning model.

12. A method according to claim 1, wherein the sample comprises a feature, the feature comprising a trench, hole, well or other indentation; and the probe is driven in and out of the feature during the measurement cycle.

13. A method according to claim 1, wherein the parameter of the probe comprises a height parameter indicative of a height of the probe, or the parameter of the probe comprises an angle parameter indicative of an angle of the probe.

14. (canceled)

15. (canceled)

16. A method according to claim 1, wherein the dataset input into the machine-learning model comprises more than 10 measurements acquired in the same measurement cycle, more than 100 measurements acquired in the same measurement cycle, or more than 1000 measurements acquired in the same measurement cycle.

17. A method according to claim 1, wherein the dataset input into the machine-learning model comprises plural measurements of the parameter of the probe acquired during the first drive phase and/or plural measurements of the parameter of the probe acquired during the second drive phase.

18. A method according to claim 1, further comprising scanning the probe across the sample, and performing plural measurement cycles during which the probe tip interacts with the sample, each measurement cycle comprising acquiring probe data by measuring a parameter of the probe, wherein each measurement cycle comprises a first drive phase in which the probe is driven towards the sample followed by a second drive phase in which the probe is driven away from the sample; and inputting the probe data from the measurement cycles into the machine-learning model, wherein the probe data input into the machine-learning model comprises a global dataset comprising plural datasets of plural measurements of the parameter of the probe, and each measurement in each dataset was acquired during the same measurement cycle.

19. A probe microscopy system comprising:
a probe comprising a cantilever mount, a cantilever extending from the cantilever mount to a free end, and a probe tip carried by the free end of the cantilever;
a drive system configured to drive the probe towards and away from a sample;
a measurement system configured to acquire probe data in a measurement cycle during which the probe tip interacts with the sample, wherein the measurement cycle comprises a first drive phase in which the probe is driven towards the sample followed by a second drive phase in which the probe is driven away from the sample, and the probe data is acquired by measuring a parameter of the probe;
a machine-learning model; and
a module configured to input the probe data into the machine-learning model, wherein the data comprises a dataset of plural measurements of the parameter of the probe acquired during the same measurement cycle.

20. A system according to claim 19, wherein the module comprises a training module configured to input the probe data into the machine-learning model, thereby training the machine-learning model by machine learning.

21. A method according to claim 1, wherein the probe data is acquired by measuring two or more parameters of the probe, and the probe data input into the machine-learning model comprises plural measurements of each parameter of the probe acquired during the same measurement cycle.

22. A method according to claim 21, wherein the two or more parameters comprise a height parameter indicative of a height of the probe and one or more angle parameters indicative of an angle of the probe.

23. A method according to claim 21, wherein the two or more parameters comprise a flexural angle parameter indicative of a flexural angle of the probe, and a torsion angle parameter indicative of a torsion angle of the probe.

24. A method according to claim 21, wherein the two or more parameters comprise a height parameter indicative of a height of the probe, one or more angle parameters indicative of an angle of the probe, a flexural angle parameter indicative of a flexural angle of the probe, and a torsion angle parameter indicative of a torsion angle of the probe.
